(19) United States
(12) Patent Application Publication
(10) Pub. No.: US 2007/0097555 A1
(43) Pub. Date: May 3, 2007

(54) Spintronic magnetoresistive device, production method thereof and applications of same

(76) Inventor: Nicolas Garcia Garcia, Madrid (ES)

Correspondence Address: KLAUBER & JACKSON, 4TH FLOOR, 411 HACKENSACK AVE., HACKENSACK, NJ, 07601, US

(21) Appl. No.: 11/512,758

(22) Filed: Aug. 30, 2006

Related U.S. Application Data
(63) Continuation of application No. PCT/ES05/70022, filed on Feb. 25, 2006.

(30) Foreign Application Priority Data
Mar. 1, 2004 (ES) P200400486

(51) Int. Cl. G11B 5/33; G11B 5/127

(52) U.S. Cl. 360/313

(57) ABSTRACT

The invention relates to the production of magnetic field sensor devices whose operation is based on the phenomenon of ballistic magnetoresistance (BMR). The inventive spintronic magnetoresistive device differs from other existing devices in that the nanocontacts are formed by the inclusion of one or more micro and/or nanometric ferromagnetic particles located between two electrodes which serve as contacts with suitable metallic scales and/or electrochemical deposits. The configuration of the particle or particles forming the contact area (as well as the materials used in the electrodes and the particles) can vary. The aforementioned magnetic sensors display high magnetoresistance (MR) values and, more importantly, said devices remain stable for long periods of time.

### RELATED APPLICATIONS

The present application is a continuation of Co-pending PCT Application No. PCT/ES2005/070022, filed on Feb. 25, 2005, which in turn, claims priority from Spanish Application Serial No. P200400486, filed on Mar. 1, 2004. Applicants claim the benefits of 35 USC §120 as to the PCT application, and priority under 35 USC §119 as to the said Spanish Application, and the entire disclosures of both applications are incorporated herein in their entireties.

### STATE OF THE ART

Magnetoresistance (MR) is a characteristic of electronic transport which depends on spin orientation. That is, the orientation of the spins alters the electrical resistance of a circuit or of a device. This effect is tremendously important in applications of information storage in magnetic memories, because with it, we can “read” and/or “write” through changes in the resistance which correspond to magnetic codes (spin orientations). Spin electronic sensors are also found which are used for other applications.

The current technologies for data storage in magnetic memories are very close to their theoretical limits (data density per unit area); for which reason it has become necessary to develop new MR read/write devices through the application of new technologies. The current technological limits of said devices would be near 150 Gb/in2, while the current surface area data density is 15 Gb/in2.

Magnetoresistance has been studied using nanocontacts manufactured between wires of ferromagnetic material, obtaining ballistic magnetoresistance (BMR) results of 200% (N. García, M. Muñoz and Y.- W. Zhao, Phys. Rev. Lett. Vol. 82, 2923 (1999)). On the other hand, magnetic nanocontacts have also been produced between two electrodes by electrodeposition of ferromagnetic material, improving the previous results and obtaining magnetoresistance values of 500-700% at room temperature (N. Garcia, et al., Applied Physics Letters 79, 4550(2001)).

Besides the problems inherent in their production (mechanical production or electrodeposition), this type of device encounters difficulties that impair its possibilities of commercialisation, for example:
poor reproducibility of the results, and
instability of the contacts, which reveal substantial decreases in or disappearance of the magnetoresistance after a certain time (which can be hours or days).

### DESCRIPTION OF THE INVENTION

The present invention is based on the inventors having observed that it is possible to obtain high magnetoresistance values, between 100% and 1500% or higher, when weak magnetic fields are applied by means of a new configuration of electronic contact on the nano- or micrometric scale based on the phenomenon of ballistic magnetoresistance (BMR), which can be applied to the production of magnetoresistive spintronic devices, like for example, readers/writers of magnetic memories or also potentiostats or another type of magnetic sensor in which applying a magnetic field changes the current.

As disclosed below, the devices manufactured in the present invention, suitably fabricated, provide results consistent with magnetoresistance values of 100% or more (as can be seen in FIGS. 6 and 8, values can be obtained of up to 1500% and even higher), and they are much more stable structurally with time (testing has been going on for six months with hundreds of resistance versus field cycles), hence they have the advantages of the sensor devices produced by electrodeposition, but moreover they eliminate their main disadvantages, and therefore, they are very interesting for applications at a commercial level. For this reason, with devices like those disclosed in the present invention applied as readers/writers of magnetic memory systems (FIG. 1), it would be feasible to reach theoretical densities of the order of Tb/in2 (1000 times greater than current values).

For the BMR to take place, the diameter of the conduction channel (nanocontact) has to be smaller than the spin mean free path of the electrons that pass through it. This results in the scattering of the electrons, in the area of the contact, being limited by the magnetic effects, hence the usefulness of nanocontacts as magnetic sensors (FIG. 2).

The fabrication of nanometric contacts represents a major challenge when implementing a magnetoresistive spintronic device with technological applications such as potentiostats, in which there is no electric contact and they are made by means of application of a magnetic field. As already mentioned, the problems to be overcome are related with the stability of the contacts and the reproducibility of the results.

Thus, an object of the present invention is constituted by a magnetoresistive spintronic device, hereinafter the device of the present invention, wherein the contact or nano- and/or micrometric gap is formed by the inclusion of one or more magnetoresistive (or ferromagnetic) particles of the material which forms the contact and of a size compatible with that of the gap and in that the configuration of said contact is constituted by one or more firmly pressed particles, or by electrodeposition in order to give it consistency, in a small channel (c) produced in an insulating layer (b) between two conductive films (a) which act as electrodes connected to the wires of the circuit (d) (FIG. 4).

The configuration of the present invention is based on two electrodes which form a gap, connected to each other by particles of the material which forms the nanocontact. The configuration of the contact can vary from a single particle (FIG. 3) located in the gap, to an array of compacted particles (FIG. 5). These particles can have nanometric, submicrometric and/or micrometric dimensions.

A particular object of the invention is constituted by the device of the invention wherein the electrodes can be magnetic or non-magnetic and can be mounted in any configuration (vertical, horizontal, etc.), allowing the disposition of one or more ferromagnetic particles which will close the gap in a stable manner. In addition, the precise location of the particles in the gap is important, to allow the formation of a contact whose magnetoresistive response is not diminished by magnetoelastic response, it increases or remains stable, of the particles nor of the electrodes (if they are magnetic). In particular, the geometry of the channel in which the ferromagnetic particle or particles are introduced or deposited can be cylindrical or conical.

Another particular object of the present invention is constituted by the device of the invention with a configuration in which the particles (again there can be only one particle) (C), the electrodes and the wires (A) are located on the same plane, the particles being firmly stuck in the gap (B) to form the contact (FIG. 5).

Another particular object of the present invention is constituted by a device of the invention based on the great variation of electrical resistance at different voltages or currents applied with the magnetic field fixed, that is, there is no need to vary the magnetic field, changing the measurement current is sufficient.

Another particular object of the present invention is constituted by a device of the invention wherein the insulating layer is a polymeric paste.

Another particular object of the present invention is constituted by a device of the invention wherein the conductive films are made of tin.

Another particular object of the present invention is constituted by a device of the invention wherein the ferromagnetic particle or particles which form the contact are Fe, Ni, CuFe, CuNi, FeSiB and Permalloy (Fe20Ni80).

Another particular object of the present invention is constituted by a device of the invention wherein the ferromagnetic particle or particles which form the contact have been manufactured by means of a procedure which allows nanometric, submicrometric and/or micrometric particles to be obtained. In particular, a procedure which allows said particles to be obtained with oxides of magnetic material having empty levels with high spin polarization on their surface.

Another particular object of the present invention is constituted by a device of the invention wherein the ferromagnetic particle or particles which form the contact have been manufactured by means of mechanical grinding in a vacuum, ambient atmosphere or nitrogen atmosphere.

Another particular object of the present invention is constituted by a device of the invention wherein the ferromagnetic particle or particles which form the contact have been manufactured by means of “spark corrosion”.

Another object of the present invention is constituted by a procedure for the manufacture of the device of the present invention, hereinafter the procedure of the present invention, wherein the particles are positioned in the contact by means of mechanical methods of embedding or electrodeposition in the following way:

a) it consists in inserting the particles forming an insulating sandwich between two conductive films (electrodes, see FIG. 4), or

b) disposition of particles firmly arranged between the electrodes and the whole device located in the same plane (FIG. 5).

The placement of nano- or micrometric particles in the gap that is present between two electrodes will not necessarily produce a magnetoresistive sensor. The-variables to control to obtain the desired results are many and complex, for example:

Ferromagnetic material used in the particles

Efficiency of the electrode/particle contact

Formation of oxides in the gap.

The configuration of the particle or the particles which form the contact area, as well as the materials used in the electrodes and in the particles can vary, as has been mentioned already. The particles are important because they provide the appropriate ferromagnetic material since they can be manufactured from all types of ferromagnetic material and because their contacts can be consolidated and isolated from the exterior by being encapsulated. Also during the manufacturing process of the micro-, submicro- and nano-particles, the latter acquire other elements (like oxygen, sulphur, etc.) which can enhance their magnetoresistive properties. All these possible adaptations of the device of the present invention form part of the same.

Finally, another object of the present invention is constituted by the use of the device of the present invention in the elaboration of a magnetoresistive sensor device, for application preferably, by way of illustration and without restricting the scope of the present invention, in the manufacture of a reader/writer of magnetic memory systems and of potentiostats for application of magnetic field with current variation or other devices in which by applying a magnetic field the electric current varies. Moreover, the details of this invention show that it can also be applied to devices, not only magnetoresistive, but also of current variation at zero magnetic field. As illustrated in FIG. 8, in the upper graph, which was plotted at zero magnetic field, there is a variation in the electrical resistance by a factor of 2 by only changing the current to 10 microamperes.

### DESCRIPTION OF THE FIGURES.

FIG. 1.—Schematic view of a MR magnetic reader head. The nanometric size of the MR magnetic reader heads allows smaller information bits to be read, and therefore packed in a more compact form, which allows large information storage capacities.

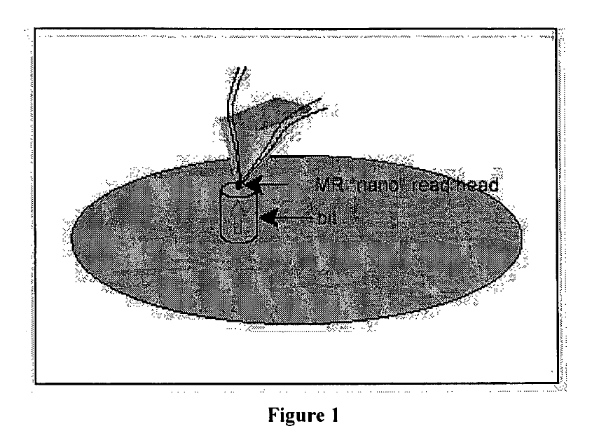

FIG. 2.—Schematic view of the nanocontact which connects the two macroscopic electrodes magnetized in opposing directions. The diameter of the contact is in the nanometer range and the electrons that pass through it conserve the spin, which produces a variation in the resistance. This allows the magnetic coding of the information between the ferromagnetic or anti-ferromagnetic configurations.

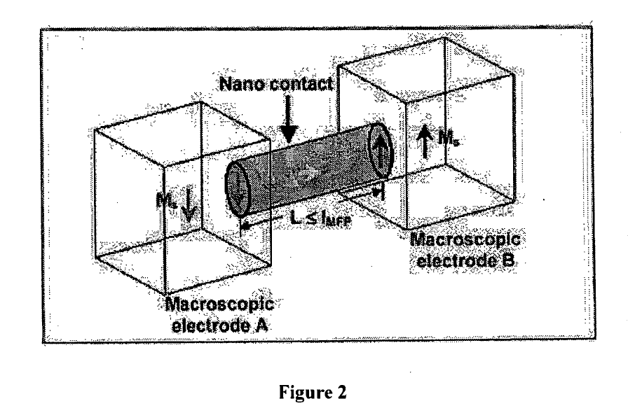

FIG. 3.—Image of a ferromagnetic particle, stuck in a rigid substrate. This image was obtained with an atomic force microscope (AFM). The scan is 100 nm and the diameter of the particle is 70 μm. The particles can be bigger in size or much smaller, but the form and structure will always be similar to that which is shown in this figure. The particles are important because they provide the appropriate ferromagnetic material since they can be manufactured from all types of ferromagnetic material and because their contacts can be consolidated and isolated from the exterior by encapsulation. Also during the manufacturing process of the micro- and nanoparticles, they acquire other elements (like oxygen, sulphur, etc.) which could enhance their magnetoresistive properties.

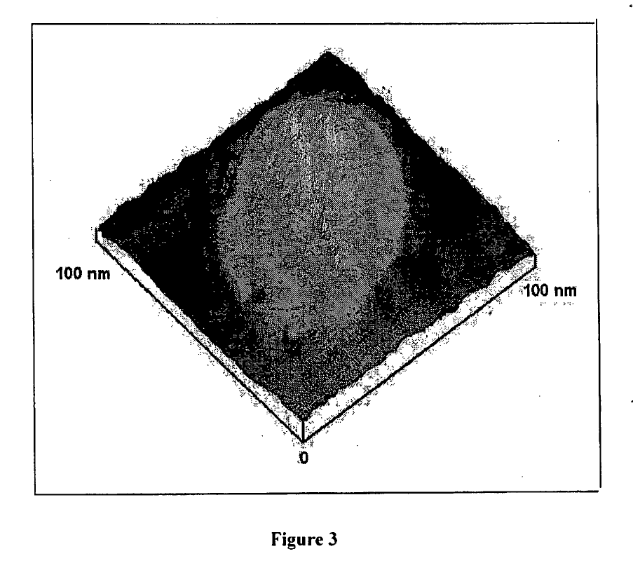

FIG. 4.—Basic configuration of the device of the present invention. One or more particles are pressed firmly into a small channel (c) produced in an insulating layer (b) between two conductive films (a) which act as electrodes connected to the wires of the circuit (d).

FIG. 5.—Another basic configuration of the device of the present invention. In this device, the particles (it can also be only one particle) (C), the electrodes and the wires (A) are located on the same plane. The particles are stuck firmly in the gap (B) to form the contact, the contacts are produced by embedding or electrodeposition.

FIG. 6. Experimental curve which shows the variation of the electrical resistance in terms of the applied magnetic field, obtained with a device of the type of FIG. 4, in which the nanoparticles were manufactured by means of mechanical grinding during 200 hours in a vacuum atmosphere (10⁻⁴ Torr) using Fe. The current used in measuring the resistance was 0.002 mA and the MR obtained was 1500%.

FIG. 7. Experimental curve which shows the variation of the electrical resistance in terms of the applied magnetic field, obtained with a device of the type of FIG. 4, in which the nanoparticles were manufactured by means of spark corrosion using Nickel. The current used in measuring the resistance was 0.002 mA and the MR obtained was more than 100%.

FIG. 8.—Experimental curve that shows the variation of the resistance with the current used in the measurement. The top curve was plotted without any external magnetic field applied and the bottom one with a magnetic field of 5000 Oe.

### EXAMPLE OF EMBODIMENT

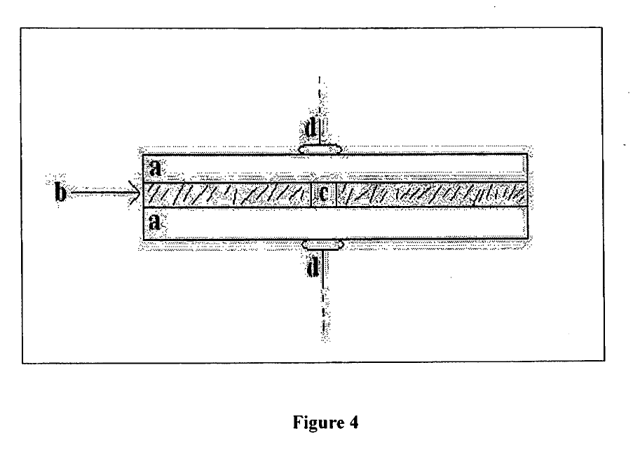

A great number of magnetoresistive spintronic devices has been implemented of the type in which the nanometric contact is formed by inclusion of one or more ferromagnetic particles in a channel produced in an insulating layer (in this case a polymeric paste was used) which is located between two conductive films (in this case, tin) which act as electrodes connected to the wires of the circuit (see FIG. 4a). For obtaining the ferromagnetic nanoparticles two different manufacturing procedures and diverse materials were used. The manufacturing methods employed were mechanical grinding and spark corrosion, but it could also have been any other that allowed nanometric particles (nanoparticles) to be obtained of the desired sizes. The materials employed were Fe, Ni, CuFe, CuNi, FeSiB and Permalloy (Fe20Ni80).

The devices which showed best properties were obtained using the mechanical grinding method and Fe. The grinding of the Fe balls was carried out in different atmospheres (vacuum of 10⁻⁴ Torr, ambient atmosphere and nitrogen atmosphere), for periods of time which varied between some minutes and 250 hours. The Fe nanoparticles so obtained had sizes of the order of 40 nm, as observed by means of X-rays. To form the contact, small quantities of these nanoparticles were taken and inserted in a cylindrical cavity of about two millimetres in diameter carried out in the insulating material. The resulting column of nanoparticles was subsequently compressed by means of a metallic pole of tin which acted as electrode. The obtained results depend greatly on how the powders are prepared, since it is essential that oxides or other surface materials are formed suitable for obtaining good contacts, as explained in our patent application WO 2004/010442 A1 PCT with the title “Solid material with structure of quasi-completely polarized electronic orbitals, the procedure for obtaining the same and its use in electronics and nanoelectronics (international publication dated 29 Jan. 2004).

In the following table some typical values are shown, reproduced consistently:

| | | | Typical value |
|---|---|---|---|
| Type of | | Mean size | of the |
| atmosphere | Milling time | of the powder | magnetoresistance |
| Vacuum | 200 hours | 40 nm | 1000% |
| (10⁻⁴ Torr) | | | |
| Nitrogen | 20 hours | 100 nm | 400% |

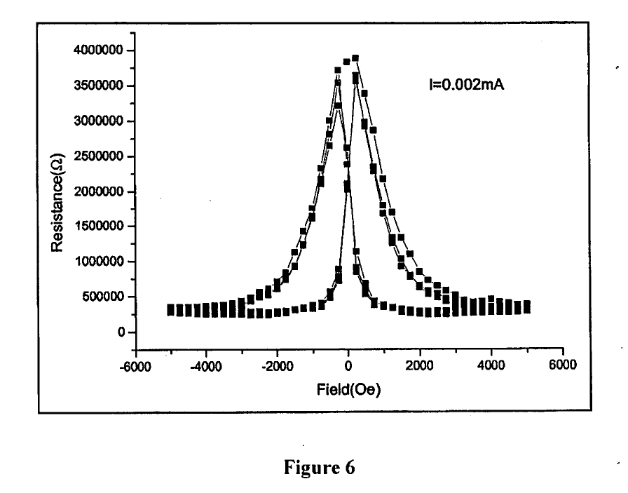

In FIG. 6 the experimental curve is shown corresponding to the variation of the electrical resistance in terms of the applied magnetic field, obtained from one of such devices. The current used in the measurement of the resistance was 0.002 mA and the MR obtained was more than 1500%.

As mentioned above, devices were also fabricated using nanoparticles of other materials different to Fe, but they showed lower magnetoresistance.

The geometric configuration used in the example of embodiment is not necessarily the most beneficial for obtaining the desired magnetoresistive results, it is simply the one that was used. However, there should be a great number of configurations that give good results. The device developed here consists of a number of very large particles (what is termed a statistical set), and the properties are evidently a mean of the contacts present between the particles. This implies that there will be contacts with greater magnetoresistance and coercitivity than others. Therefore, some contacts will have magnetoresistive values very much higher than those measured as a mean of all of them. Thus, it would be possible to obtain devices with much greater magnetoresistance by changing for example the geometry of the cavity from cylindrical to conical and selecting nanoparticles of very high magnetoresistance for the interface which the end of the cone forms with the metallic contact.

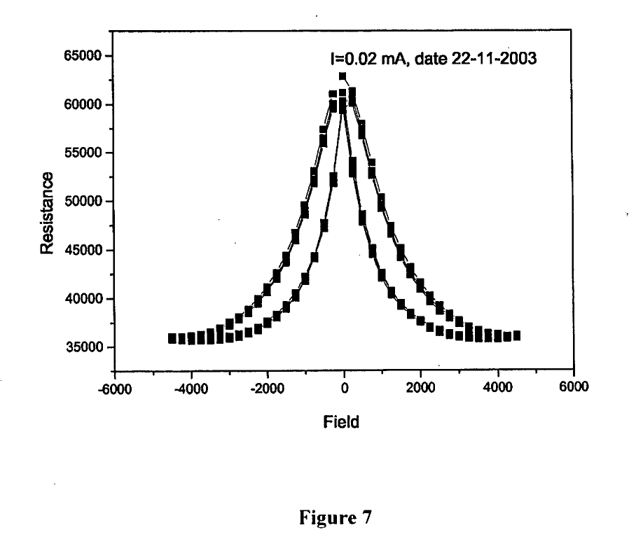

In FIG. 7 the experimental curve is shown corresponding to the variation of the electrical resistance in terms of the applied magnetic field, obtained from a device in which the nanoparticles of the contact were obtained by means of spark corrosion using Nickel. The current used in the measurement of the resistance was 0.002 mA and the MR obtained was more than 100%.

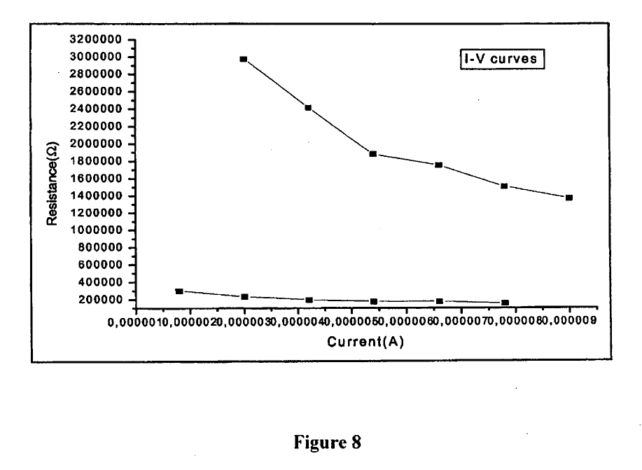

In FIG. 8 the resistance (ordinates) is shown with the measurement current (abscissa) for two applied magnetic fields. Top curve, zero field, and the bottom one, a field of 5000 Oe.

1. Magnetoresistive spintronic device wherein the nano- and/or micrometric contact or gap is formed by the inclusion of one or more magnetoresistive (or ferromagnetic) particles of the material which forms the contact and of a size compatible with that of the gap and in that the configuration of said contact is constituted by a particle or several particles pressed firmly in a small channel, or by electrodeposition to give it consistency, (c) produced in an insulating layer (b) between two conductive films (a) which act as electrodes connected to the wires of the circuit (d) (FIG. 4).

2. Device according to claim 1 wherein the configuration of the contact includes a single particle.

3. Device according to claim 1 wherein the configuration of the contact includes more than one particle.

4. Device according to claim 1 wherein the electrodes can be magnetic or non-magnetic and they can be mounted in any configuration (vertical, horizontal, etc.), allowing the disposition of one or more ferromagnetic particles which close the gap in a stable form.

5. Device according to claim 1 wherein the geometry of the small channel in which the ferromagnetic particle or particles are introduced or deposited is cylindrical.

6. Device according to claim 1 wherein the geometry of the small channel in which the ferromagnetic particle or particles are introduced or deposited is conical.

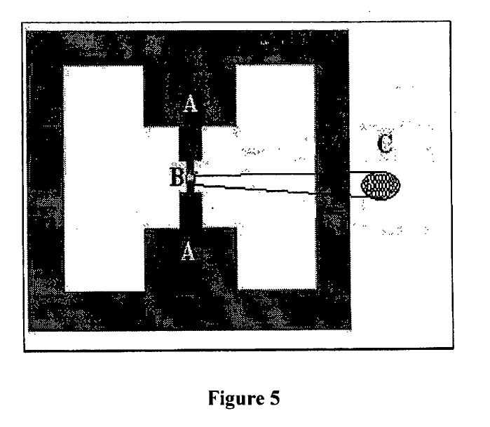

7. Device according to claim 1 wherein the configuration of the particles (it can also be only one particle) (C), the electrodes and the wires (A) are located in the same plane, the particles being stuck firmly in the gap (B) to form the contact (FIG. 5).

8. Device according to claim 1 wherein it is based on the great variation of the electrical resistance at different voltages or currents applied with the magnetic field fixed.

9. Device according to claim 1 wherein the insulating layer is a polymeric paste.

10. Device according to claim 1 wherein the conductive films are made of tin.

11. Device according to claim 1 wherein the ferromagnetic particle or particles which form the contact are Fe, Ni, CuFe, CuNi, FeSiB and Permalloy (Fe20Ni80).

12. Device according to claim 1 wherein the ferromagnetic particle or particles which form the contact have been manufactured by means of a procedure which allows nanometric, submicrometric and/or micrometric particles to be obtained.

13. Device according to claim 1 wherein the ferromagnetic particle or particles which form the contact were manufactured by means of a procedure which allows nanometric, submicrometric and/or micrometer particles to be obtained with oxides of magnetic material of empty levels with high spin polarization on their surface.

14. Device according to claim 1 wherein the ferromagnetic particle or particles which form the contact were manufactured by means of mechanical grinding in a vacuum.

15. Device according to claim 1 wherein the ferromagnetic particle or particles which form the contact were manufactured by means of mechanical grinding in an ambient atmosphere.

16. Device according to claim 1 wherein the ferromagnetic particle or particles which form the contact were manufactured by means of mechanical grinding in a nitrogen atmosphere.

17. Device according to claim 1 wherein the ferromagnetic particle or particles which form the contact were manufactured by means of spark corrosion.

18. Procedure for the fabrication of a magnetoresistive spintronic device, wherein said device has a nano- and/or micrometric contact or gap that is formed by the inclusion of one or more magnetoresistive (or ferromagnetic) particles of the material which forms the contact and of a size compatible with that of the gap and in that the configuration of said contact is constituted by a particle or several particles pressed firmly in a small channel, or by electrodeposition to give it consistency, (c) produced in an insulating layer (b) between two conductive films (a) which act as electrodes connected to the wires of the circuit (d) (FIG. 4); wherein in said method, the particles are positioned in the contact by means of mechanical methods of embedding or electrodeposition in the following way:
a) it consists in locating the particles forming an insulating sandwich between two conductive films (electrodes, see FIG. 4), or
b) disposition of particles arranged firmly between the electrodes and the whole device located in the same plane (FIG. 5).

19. Device according to claim 1 comprising a magnetoresistive sensor device.

20. Device according to claim 19 wherein the magnetoresistive sensor device is a reader/writer of magnetic memory systems.

21. Device according to claim 19 wherein the magnetoresistive sensor device is a potentiostat or another type of magnetic sensor in which applying a magnetic field changes the current.

22. Device according to claim 1 comprising a current variation device at zero magnetic field.
